(19) United States
(12) Patent Application Publication
(10) Pub. No.: US 2023/0297042 A1
(43) Pub. Date: Sep. 21, 2023

(54) METHOD OF CONTROLLING THE OUTPUT OF AN INDUSTRIAL PROCESS

(71) Applicant: CITY UNIVERSITY OF HONG KONG, Kowloon (HK)

(72) Inventors: Si-Zhao QIN, Kowloon (HK); Yiren LIU, Kowloon (HK)

(21) Appl. No.: 18/183,015

(22) Filed: Mar. 13, 2023

Related U.S. Application Data
(60) Provisional application No. 63/320,624, filed on Mar. 16, 2022.

(51) Int. Cl. G05B 13/04

(52) U.S. Cl. CPC G05B 13/041

(57) ABSTRACT

A method of adjusting the inputs to an industrial process, which can be any process such as the chemical, pharmaceutical, food processes and so on, comprising modelling the process output based on the input variables using regression techniques. The method provides for pre-identified variables not to be subjected to the penalty while the other variables may be penalised to zero by the regression techniques. This provides a model which can discriminate between the variables.

### CROSS-REFERENCE TO RELATED APPLICATION

This application claims priority to U.S. provisional application No. 63/320,624 filed on Mar. 16, 2022 in the United States Patent and Trademark Office entitled, “A METHOD OF KNOWLEDGE-INFORMED LEARNING FOR RELEVANT VARIABLE SELECTION AND OPTIMAL PREDICTION OF KEY INDICES”, which is incorporated herein by reference in its entirety.

### FIELD OF INVENTION

The present invention relates to industrial processes that comprises many performance factors. In particular, the present invention relates to a method of controlling the process by identifying performance factors that are significant and those that are not.

### BACKGROUND OF THE INVENTION

Chemical processes in large scale plants have many inputs, including raw materials, heating, pressure, flow of material, control of the exchange and interaction of the different inputs, and soon. Unlike on a lab bench top, large scale productions can be very difficult to optimise. Any miscalculation of the movement and exchange of mass and energy can potentially blow up a plant.

Essentially, it is impossible to take a mono-variate approach to fully understand every variable in such large processes and reactions. A mono-variate approach would require holding all other variables constant while changing one variable to study the effect of that variable on the process. There are just too many variables each of which is too costly to observe by holding other variables constant on a plant scale. Many plant scale processes comprise hundreds or even thousands of variables.

Multi-variate analysis approaches have been proposed, which include iterative processes that can consider multiple variables, and identify which of the multiple variables have a significant effect on the process output, and then produce a model for predicting the effect of each of the significant variables on the process.

An example is the study of the variables that contribute to waste products such as NOx produced in a process, which can be aggravated by heat, flowrate and mass of reactants, and so on, which are too many to study one by one.

To study a process that has multi-variables, the fundamental approach is to use regression techniques to fit a model to training data that comprises readings of all the variables. If the model is accurate, the model can then be used to predict the outcome of the same process in future operations based on the values of the variables.

One problem with developing a model that fits well to training data of many variables is that the model may end up fitting the training data so perfectly that the model is only good for modelling the test data; the model deviates significantly once used on another set of data.

Hence, advanced regression techniques have been developed that reduces or penalises the model fit to test data, in order that; the model becomes applicable more generally to other sets of data of the same process by becoming less perfectly fitted to the training data.

Two most commonly use of such advanced regression techniques are the Ridge regression and Lasso regression.

Basically, Ridge regression applies a factor to the slope of each variables. In a single straight line formula, the slope is the m in the famous y=mx+c that scales the variable x. The value of the slope m is obtained by normal, linear regression. In Lasso and Ridge regression notation, the factor is virtually always represented by, A, lambda. A is also called the hyperparameter.

There are many variables in a complex process, and each of these variables x₁, x₂, . . . xₙ has its own slope m₁, m₂ . . . mₙ, and each contributes to the final outcome y of the model.

λ is applied to all the slopes in the model and therefore “penalizes” the slope mₙ of each variable xₙ, which reduces the fit of the model to test data. This makes the final model more generally applicable to other sets of data of the same industrial process, and therefore more useful in predicting the outcome of the process in more situations.

In both Lasso and Ridge regression, the initial value of Δ is chosen arbitrarily. A is tested on the model obtained by training data, adjusted and re-tested on the training data. Over many iterations trying out different Δ values, the λ value will be found that gives a process output value that is the same as the real process output value when the values of the variables were obtained for training data.

Lasso regression is similar to Ridge regression with one difference. λ in Ridge regression is applied to the square of the slope of each variable, we call it the L2 norm penalty. But in Lasso regression, λ is applied to the absolute magnitude of the slope, we call it the L1 norm penalty.

Due to the different nature of L1 and L2 penalty, it is impossible in Ridge regression that the slopes are reduced to zero. However, it is possible in Lasso regression that some of the variables are reduced to zero by A. This difference makes Lasso regression particularly suitable for identifying variables that are not significant for the process; the slope of variables that can be reduced by A to zero are not significant variables for the process output for that model.

Ridge regression is more suited for modelling a process that has many collinear variables. Collinear variables are independent variables that may seem to be related because the variables appear to change in tandem. This is because Ridge regression does not eliminate variables, all variables remain in the model even if any of the variables are collinear. In contrast, Lasso regression eliminates all variables that appear collinear by reputedly testing different values for λ, until only one of each set of collinear variables remains. However, some variables may seem collinear when they are not. In this case, then the model may become inaccurate for wrongly deeming a significant variable as unimportant, i.e. because the variable can be eliminated by a certain λ value.

A further technique called the Elastic net regression simply combines the Ridge regression and Lasso regression on the same set of data. In this case, there are two different λ's, one for Ridge regression and the other for Lasso regression. If λ for Ridge regression is set to 0 but λ for Lasso regression is set to more than zero, the final model is simply a Lasso regression model. Similarly, if λ for Ridge regression is set to more than 0 but λ for Lasso regression is set to zero, the final model is simply a Ridge regression model.

However, if both of λ's are not zeros, then the best of both regression techniques are obtained, i.e. independent but collinear variables will not be unknowingly eliminated as Ridge regression will preserve the variables, while inconsequential variables are identified by elimination in Lasso regression.

Accordingly, sparse statistical machine learning methods based on Ridge regression, Lasso regression and Elastic-net regression have found use in optimising manufacturing and industrial processes. In particular, these techniques are able to identify which are the significant variables, and also identify the parameters of the variables simultaneously.

To providing many datasets for testing different λ values without actually running the process many times, cross-validation (CV) has been used. Cross-validation is not a regression technique but a technique of re-using the same set of data multiple times to train and test regression models in order to find the best model. Cross-validation refers to the method of breaking up a single set of data in a different way every iteration, so that one different part of the data can be used to train the model and the remaining part can be used to test the model in each iteration. The same set of data is reused repeatedly, but each time separated differently into different portions. Each time, one of the portions is used to train the model, and the trained model applied to the other portion to test the model.

However, models produced by despite these advance regression techniques still have much room for improvement, as there are still occasions that models may fail to predict outcomes satisfactorily. An example of such shortcomings is explained here below.

Let xₖ=[x₁, x₂, . . . , xₚ]^{T}∈Rₚ include all potential variables to be selected to predict the response variable yₖ. For convenience these variables are scaled to zero mean and unit variance based on N samples in the training set. The regression coefficients are estimated based on

yₖ=β₀+xₖ^{T}β+εₖ,

yₖ=β₀+xₖ^{T}β+εₖ, (1)
where
β₀=0 for zero-mean xₖ; and
yₖ, where εₖ is random noise.
The Lasso approach adopts the/1 norm penalty of the coefficients as

$${\hat{β}}_{λ} = arg {min}_{β} \frac{1}{2 N} {{Σ}_{k = 1}^{N} ( {y}_{k} - {x}_{k}^{T} β )}^{2} + λ {‖ β ‖}_{1} , \qquad ( 2 )$$

where
λ is the hyperparameter to be tuned based on cross validation.

Denoting the data matrices X=[x₁,x₂, . . . ,x_{N}]^{T}∈R^{N×P} and [y₁, y₂, . . . , Y_{N}]^{T}∈R^{N}, (2) is equivalent to

$${\hat{β}}_{λ} = arg {min}_{β} \frac{1}{2 N} {‖ y - X β ‖}_{2}^{2} + λ {‖ β ‖}_{1} . \qquad ( 3 )$$

Properties such as consistency of the Lasso estimate \hat{β}_{λ} and bounds on the prediction errors have been considered discussed, i.e. whether the Lasso estimate \hat{β}_{λ} can recover the true sparsity of the true parameters β*.

Denoting the index set of non-zero elements of β* as S(β*) ⊂{1:p} and the cardinality of this set as c=|S(β*)|, typical Lasso analysis assumes that β* is c-sparse, which means that the cardinality of S(β*) is no greater than c.

To inferentially predict the output of a real industrial process, however, it is difficult to fulfil this assumption. This is because all variables in a process tend to be more or less related. Therefore, a weak sparse model is often estimated instead, which merely seek to estimate the best c-sparse approximation of the true β*.

Lasso analysis usually requires the smallest eigenvalue of X^{T}X/N to have a positive lower bound, and X is referred to as the design matrix. A less restrictive assumption would require the smallest eigenvalue of X_{S}^{T}X_{S}/N to have a positive lower bound, where S is the set of variables selected in the Lasso model.

In a real industrial process, however, even such a less restrictive condition can be difficult to satisfy since variables of the industrial process are often highly collinear, due to the principles of mass balance and energy balance that affect every physical and energy related variable. The data matrix X is from routine operations of the process.

Collinearity between variables leads to two potential issues. Firstly, collinearity makes the smallest eigenvalue of X^{T}X/N close to zero.

Secondly, if an important variable has significant effect on the process output but is collinear with several other process variables, it is possible that this important variable is substituted by any of the collinear ones by Lasso regression. That is, a collinear variable is mistaken for the important variable as both variables appear similarly proportional to the relevant process output.

This is the issue of variable-selection consistency, which is adversely affected by variable collinearity.

To characterize how much a variable xⱼ is collinear with other variables in a subset S, mutual coherence or representability between the variables is defined. Let Xₛ include the columns of the subset S and xⱼ be the j^{th} column in X with j∉S.

The representability of xⱼ by the variables in S is defined as

ρⱼ=∥(X_{S}^{T}X_{S})X_{S}^{T}xⱼ∥₁ (4)
for j∉S,
where
the columns of X are scaled to unit variance.

The limiting case of ρⱼ=1 makes variable xⱼ,j∉S perfectly represented by the subset S, which makes it impossible to achieve variable-selection consistency. This possibility points to the limitation of a purely data-driven method for variable selection.

Accordingly, application of the regression techniques of the prior art may sometimes obscure the truly significant variables.

### SUMMARY OF THE INVENTION

In the first aspect, the invention proposes a method of controlling the output of an industrial process, comprising the steps of:
a) obtaining data for variables in an industrial process;
b) identifying key-variables among the variables;
c) treating the data with using Least Absolute Shrinkage And Selection Operator (Lasso) type regression in which the value of a factor is selected and applied to the parameter of each variable that is not a key-variable to produce a model of the industrial process;
d) applying the model to tune the variables to control the output.

The above method is termed Knowledge-Informed Lasso Regression in this description (KILR). Typically, the Lasso type regression may be Lasso regression, Lasso-Ridge regression or Lasso-Lasso regression. In KILR, variables pre-identified to have known effects on a process output are prevented from being penalised by the Lasso regression. This ensures that the variables are preserved from being eliminated by Lasso regression. In other words, the proposed method allows discrimination of certain variables, which is not possible in the prior art Lasso regression. Not being able to discriminate variables means all variables are treated equally by the regression technique, and this is not always the case in real life industrial process.

Preferably, the method comprises the further steps of: preliminarily treating the data with using Lasso regression or Least Angle Regression (LARS) in which the value of a factor is selected and applied to the parameter of each variable to produce a preliminary model; and if the preliminary treatment renders the parameter of a key variable to zero, performing step c) and step d); if the preliminary treatment does not render the parameter of any key variable to zero, providing the preliminary model as the model of the industrial process. These further steps are preferably conducted before the earlier-described steps of KILR. This is because, if possible, the knowledge-informed variables should be subject to the hyperparameter λ and be penalised along with other variables, to produce the best model. Such a model is better model one in which knowledge-informed variables is not penalised at all, as one would obtain using KILR. However, in the event it is not possible for a model to be produced using Lasso-Ridge regression that retains all the knowledge-informed variables, the KILR should be used.

Typically, the process is a chemical process, a pharmaceutical process, a food making process.

Accordingly, a novel Lasso-Ridge regression approach to variable selection and inferential sensor modelling is proposed, using knowledge-based and data-driven regularization methods. The method comprises use of two stages which can be implemented as algorithms.
Algorithm 1. Lasso-Ridge with Cross Validation
Algorithm 2. A knowledge-informed Lasso Ridge (KILR) Algorithm, proposed herein.

Both stages provide the possibility of selecting relevant variables out of a larger pool of variables for modelling an industrial process. Once a model of the process is produced using the algorithm, the model can be used to predict the output of the process, allowing the variables to be tuned in real life to control the process output.

However, the KILR algorithm has an additional advantage of preventing elimination of “knowledge-informed” variables. These variables may be known to a human technician to have an effect on the output but could be “overlooked” by algorithms using the prior art modelling methods, i.e. variables that may be eliminated or reduced significantly by conventional Lasso and Ridge regressions. This is completely unintentional but unavoidable because implementation of Lasso or Ridge regressions does not discriminate between variables. All variables are ruthlessly subject to elimination or reduction. If the technician implementing regression algorithms wants to include a variable as part of a model, the variable is subject to elimination by being treated in the same way as all the other variables. If the technician does not want a certain variable eliminated, then the technician cannot include the variable as part of the model. Furthermore, as the number of variables in a complex industrial process can be many as hundreds or thousands, it is very difficult for the technician to know if the prior art algorithms have erroneously eliminated a variable from the model.

The proposed Lasso-Ridge and KILR methods can be used to build “inferential sensor models” that can predict the output of an industrial process by making inferences based on past data. In particular, the KILR method prevents physically relevant variables from being eliminated by Lasso. These variables are not selected by the algorithms, as algorithms cannot discriminate between variables. These variables are pre-identified by the technician based on human observation, by which the technician knows that these variables must have significant influence on the process outcome. These variables are called “Knowledge-informed variables” in this specification. These variables should not be eliminated during Lasso regression by any value of A.

The proposed methods therefore have better prediction performance than prior art Lasso and/or Ridge regressions. This is because the proposed method ensures that Knowledge-informed variables are included into the models produced by the regression techniques, but the Knowledge-informed variables are not exposed to being eliminated by the regression techniques.

Furthermore, the invention provides a possibility to improve the fit of the model to actual data because the invention provides the possibility of better selection of training data. Cross-validation tends to select superficial variables based on high correlations, which often ignores variables that are preferred by physical knowledge and first principles. This problem is particularly severe in the presence of collinear variables, which is common in industrial manufacturing and operations data analytics.

In particular, Industrial process data from routine operations are usually highly collinear, which presents challenges to data-driven quality modelling problems via sparse statistical learning since physically relevant variables can be deselected and replaced by other collinear ones.

Accordingly, the proposed methods are particularly relevant to Industry 4.0 and industrial internet of things based manufacturing and operations, where key performance and quality indices are to be predicted and optimized. Relevant variables informed by domain expert and operation knowledge are retained in the predictive models, in addition to other relevant variables to be determined from data.

Accordingly, KILR allows the technician to pick any variable as a Knowledge-informed variable, and custom-make a special model of any process that retains the desired variable or feature as model input.

In other words, the KILR method and algorithm keeps knowledge or user preference in the scheme of variable selection while achieving statistically good results in prediction
i) The KILR models are more interpretable and convenient for use in control and optimization.
ii) The user can pick any ‘feature’ as a Knowledge-informed variable to custom-make a special model that retains the desired variable or feature as model input.
iii) The KILR algorithm guarantees physically informative variables are retained in the model.

In addition, the Lasso-Ridge algorithm further relaxes constraints induced by the Lasso or Elastic-nets.

### BRIEF DESCRIPTION OF THE FIGURES

It will be convenient to further describe the present invention with respect to the accompanying drawings that illustrate possible arrangements of the invention, in which like integers refer to like parts. Other arrangements of the invention are possible, and consequently the particularity of the accompanying drawings is not to be understood as superseding the generality of the preceding description of the invention.

FIG. 1 shows the selected predictors by the Lasso on all data as A varies from small to large;

FIG. 2 depicts the selected variables by the modified Lasso along the solution path, which for sure selects Steam-flow;

FIG. 3 shows the box plot of the MSEPs of the four modelling method;

FIG. 4 shows the minimum MSEP's achieved by the Lasso-Lasso, Lasso-ridge, and KILR based on the candidate model structures along the Lasso paths;

FIG. 5 is a schematic drawing of a process in three distillation columns of the well-known company Dow;

FIG. 6 depicts the MSEPs for a grid of A via cross validation are shown with circles. The minimum MSEP is achieved by the Lasso model with 24 predictors;

FIG. 7 compares the minimum MSEPs from each candidate set of variables among the three methods: Lasso-Lasso, Lasso-ridge, and KILR.

### DETAILED DESCRIPTION OF SPECIFIC EMBODIMENTS

In the present embodiment, the variables that are inputs of an industrial process are first identified. Subsequently, values of these variables are obtained when the industrial process is running, as training data to produce a model of the industrial process. The industrial process can be any plant size process, including refinery processes for crude oil, production processes for pharmaceutical products or biochemical products, production for food processes, production for materials including nanotechnology products or biomaterials, and so.

The training data is treated by Lasso-Ridge regression, using cross validation, to produce a first model. Subsequently, the model is checked to see if variables that are deemed particularly relevant to the industrial process are still included in the model, without being eliminated by Lasso regression. These particularly relevant variables are termed “knowledge-informed variables”, and are pre-identified by an experienced technician operating the industrial process. Such knowledge-informed variables should be retained in the model despite regression treatments. If so, the Lasso-Ridge regression has fulfilled the purpose of providing a useable model.

If any of such knowledge-informed variables is found eliminated by the Lasso-Ridge regression, then the Lasso-Ridge regression is repeated but with two extra steps. Firstly, Lasso regression is applied with a small modification to ensure that the identified variables are not eliminated by the hyperparameter A. The modified Lasso does not apply any constraining factor to the coefficients of the knowledge-informed variables. The other variables may be eliminated by the hyperparameter A.

Typically, such knowledge-informed variables include those input variables that are manipulatable for feedback control, and external disturbance variables for use in feedforward predictive control.

The reason for using Lasso-Ridge regression to treat the data first is because it is preferable for the model to take into consideration scaling or factoring all the variables indiscriminately, including the knowledge-informed variable. This makes the knowledge-informed variables more integrated into the model.

However, keeping knowledge-informed variables in the model is not always possible, such as when there are collinear variables that may be mistaken by the Lasso regression step of the process to be the variable responsible for a part of the process output. Hence, in the modified Lasso regression, the knowledge-informed variables are included in the training data for producing the model but protected from the penalty or factor A of the regression.

In other words, it is proposed to model the industrial process firstly using an algorithm 1 shown below, followed by an algorithm 2 also shown below if knowledge-informed variables are found to be eliminated by algorithm 1.

Algorithm 1. Lasso-Ridge with Cross Validation

Algorithm 1 comprises an improved algorithm that uses Lasso to find a series of subsets of selected variables along the solution path, followed by using Ridge regression to estimate the nonzero coefficients for each subset of selected variables. The best model structure and the estimates of non-zero coefficients are determined by tuning the hyperparameter in Ridge regression via cross validation. The algorithm is referred to as the Lasso-Ridge algorithm with cross validation.

It should be appreciated that the proposed method uses Lasso and Ridge regressions but not in the same way as in Elastic Net regression. Elastic Net regression is a one-step sparse learning method, although it combines Lasso and Ridge, it selects the subset of variables while estimating their coefficients simultaneously. Different from Elastic Net regression, the proposed Lasso-Ridge method is a two-step sparse learning method. An attractive feature of the Lasso is its ability to make some variables with exactly zero coefficients by applying a specific value for A. When the λ value increases, the number of zero coefficients increases, yielding a series of subsets of selected variables along the solution path.

Preferably, the Lasso regression is performed in several iterations using cross-validation to select a specific set of variables that gives the best cross-validation error. However, if the best set of selected variables is known, there exists a better estimate of the non-zero coefficients for the set of selected variables. Therefore, the coefficients for the selected variables should be re-estimated after the Lasso step to achieve the best mean squares prediction errors. This point leads to the Relaxo algorithm that relaxes the Lasso solution.

It has been concluded that the Relaxo algorithm generally outperforms other methods including the Lasso and the best subset selection.

The Lasso regression has the following steps.
1) Scale all training data {xₖ,yₖ}k=1 to zero mean and unit variance. Use all training data to estimate \hat{β}_{λ}^{N} in (2) for a grid of λ values from small to large. The vectors of selected variables along the solution path are denoted as xₖ¹, xₖ², . . . , xₖ^{m} without repetition, where xₖⁱ is the vector of the selected variables in Subset i.
2) Divide the training data into s fold to perform cross-validation (CV). Estimate the j^{th} fold model using the training set Tⱼ with Nⱼ observations and the remaining samples as the j^{th} validation set Vⱼ, where the union of Tⱼ and Vⱼ includes all observations. The Lasso-Ridge solution for the model with predictors xₖⁱ, i=1,2, . . . ,m, is

$${\hat{β}}_{μ}^{i j} = arg {min}_{β} \frac{1}{{N}_{j}} {{Σ}_{k ∈ {T}_{j}} ( {y}_{k} - {β}^{T} {x}_{k}^{i} )}^{2} + μ {‖ β ‖}_{2}^{2} \qquad ( 5 )$$

For each i calculate the mean squared error predicted as

$${MSEP}_{μ}^{i} = \frac{1}{N} {Σ}_{j = 1}^{s} {{Σ}_{k ∈ {V}_{j}} ( {y}_{k} - {( {\hat{β}}_{μ}^{i j} )}^{T} {x}_{k}^{i} )}^{2} \qquad ( 6 )$$

and find the μ* that yields the smallest MSEP, which is denoted as MSEP_{μ}ⁱ.
3) The minimum MSEP_{μ*}ⁱ, among i=1,2, . . . ,m gives the optimal i*. The final model estimate \hat{β}_{μ*}ⁱ* is obtained by another Ridge regression using all training data with variables in Subset i* and the hyperparameter value μ*.

This best MSEP is used to calculate the overall predicted R², which is denoted as Q² and given as follows,

$${Q}^{2} = 1 - \frac{MSEP}{\frac{1}{N} {{Σ}_{k = 1}^{N} ( {y}_{k} - \overline{y} )}^{2}} \qquad ( 7 )$$

where
y̅ is the mean of the training data, which is zero when the data is scaled to zero mean.

The Lasso-Ridge algorithm produces candidate subsets of selected variables using Lasso and estimates the best possible non-zero regression coefficients using Ridge regression. Since the variables in the candidate subsets can be collinear, the Ridge regression is capable of producing the best trade-off between the model bias and variance. However, this algorithm does not guarantee that physically relevant variables from process knowledge are selected by the Lasso. If a relevant variable is collinear with other variables, it can be replaced by another correlated variable with a pure data-driven approach.

As an alternative to Ridge regression, another Lasso can be used instead in Step 2) of the above algorithm to re-estimate the coefficients based on a given subset of variables. This is referred to as the Lasso-Lasso algorithm.

Algorithm 2. The KILR Algorithm

In industrial applications, it is desirable to include into the model variables that are i) manipulatable variables to realize feedback control; or ii) external disturbance variables to implement feedforward predictive control.

To guarantee that the knowledge-informed variables are kept in the model and not eliminated by Lasso, the following knowledge-informed Lasso-Ridge algorithm is proposed, based on modifying the Lasso-Ridge algorithm.
1) To re-cap the step mentioned above, the Lasso-Ridge Algorithm 1 (as described above) is first performed. Then the produced model is examined to see if desired physically relevant variables, i.e. knowledge-informed variables, are included in the best proposed model. If yes, the produced model may be accepted without performing Algorithm 2.
2) If desired knowledge-informed variables are not found included in the best proposed model produced by Algorithm 1, assign such physically relevant variables as “knowledge-informed variables”, and repeat the Lasso-Ridge Algorithm 1 but using the following modified Lasso objective,

$${\hat{β}}_{λ} = arg {min}_{β} \frac{1}{2 N} {{Σ}_{k = 1}^{N} ( {y}_{k} - {x}_{k}^{T} β )}^{2} + λ {‖ {β}_{- \{ k i v \}} ‖}_{1} , \qquad ( 8 )$$

where
β-_{{kiv}} is β after excluding the knowledge-informed variables to be kept in the model.

As shown above, the modified Lasso (8) applies no constraints on the coefficients of the knowledge-informed variables. That is, no penalty is applied on the slopes of the knowledge-informed variables. This modified Lasso regression is termed the Knowledge-Informed Lasso Regression (KILR) in this description.

The KILR Algorithm has been applied to actual data of a process, and the results are shown in the following section of Experimental Data.

In a second embodiment, however, Lasso is replaced by the LARS to compute the entire solution path of the Lasso in Step 1). The benefit is that the computational cost is O(Np²), which is the same order of computation as a single ordinary least squares solution.

While there has been described in the foregoing description preferred embodiments of the present invention, it will be understood by those skilled in the technology concerned that many variations or modifications in details of design, construction or operation may be made without departing from the scope of the present invention as claimed.

Experiment Data

Nox Emission Dataset

A set of data related to the operations of an industrial boiler, including NOx output, is treated with the method as described. The data comprises the values of nine process variables and NOx concentrations detected in expelled gas from the factory. The dataset used for this study has 390 observations sampled at a 5-minute interval of the process variables, i.e. nine predictors. The boiler operation data is highly collinear with nine predictors due to energy and mass balances.

A. Lasso results and instability

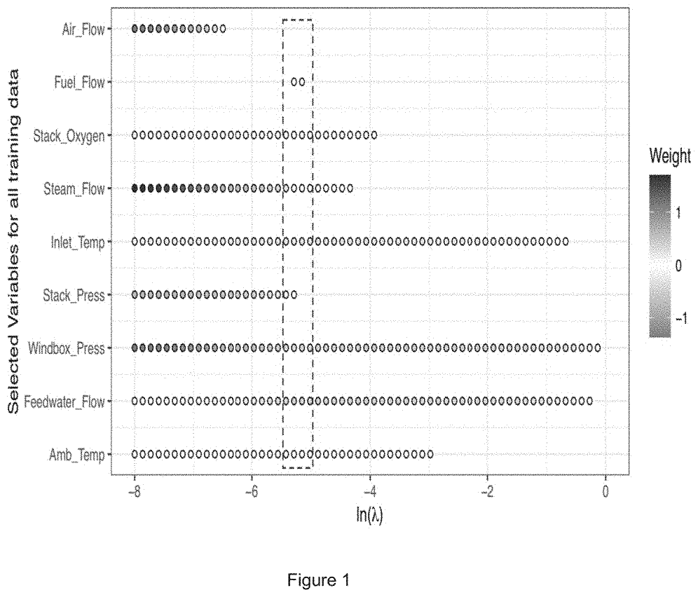

Lasso is applied to the boiler NOx emission data to generate a series of model structures along the Lasso solution path. FIG. 1 shows the selected predictors by the Lasso on all data as λ varies from small to large. The circles indicate the selected variables for each λ value, which form the candidate subsets to be used for the subsequent step to re-estimate the non-zero coefficients. The colour coding cannot be seen in the black and white version shown. Nevertheless, it is sufficient for the reader to note that the weightage is reduced to zero or that the colour coding of the circles is reduced to white for all the variables at about In(λ)=−5.5, as can be seen from the horizontal axis of the chart.

It is observed that in some regions the model structure is stable for a wide range of λ values, while in a few regions the structures change quickly, e.g., for the four λ values inside the dash-line rectangle.

Next, the sensitivity of the variable selection results is tested with minor perturbation of the training samples, using the four λ values inside the rectangle in dashed line shown in the FIG. 1.

For each λ value, three cases were tested: i) using all 390 samples, ii) randomly deleting 30 samples; and iii) randomly deleting 50 samples. The results are shown in Table I. The deselected variables in the table clearly show that the Lasso is very sensitive to small perturbations of the training samples, while the training MSEs (Mean Squared Errors) change little.

TABLE I

| | | |
|---|---|---|
| No. of samples | Deselected variables | MSE |

In(λ) = −5.42

| | | |
|---|---|---|
| All 390 | Fair, Ffuel | 0.131 |
| Random 360 | Fair | 0.125 |
| Random 340 | Fair, Fsteam | 0.126 |

In(λ) = −5.28

| | | |
|---|---|---|
| All 390 | Fair | 0.133 |
| Random 360 | Fair | 0.127 |
| Random 340 | Fair, Fsteam, Pstack | 0.127 |

In(λ) = −5.15

| | | |
|---|---|---|
| All 390 | Fair, Pstack | 0.133 |
| Random 360 | Fair, Fsteam | 0.129 |
| Random 340 | Fair, Fsteam, Pstack | 0.127 |

In(λ) = −5.01

| | | |
|---|---|---|
| All 390 | Fair, Pstack, Ffuel | 0.133 |
| Random 360 | Fair, Pstack, Fsteam | 0.129 |
| Random 340 | Fair, Pstack | 0.128 |

After the candidate subsets of variables are determined by the Lasso along the solution path, another Lasso or Ridge regression step is performed to find the optimal parameter p with a seven-fold cross-validation.

None of the above methods select the Steam-flow variable, but it is known from process knowledge that Steam-flow is an important load indicator for the boiler. If the NOx value is exceeding a desired limit, the steam load can be adjusted to reduce the NOx emission and comply with the regulations.

Therefore, the preceding steps have been unable to identify a key variable.

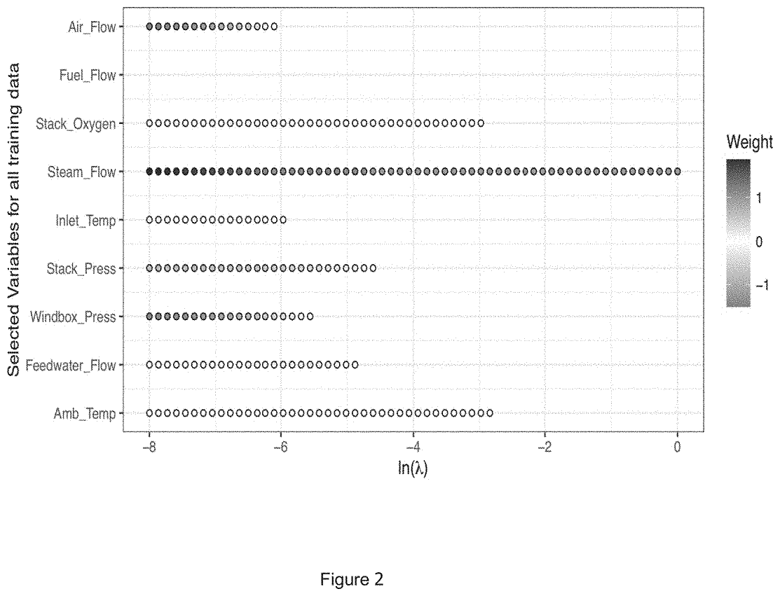

Subsequently, KILR is then performed with Steam-flow of the process identified as the KI variable. FIG. 2 depicts the selected variables by the modified Lasso along the solution path, which for sure selects Steam-flow.

Since the cross-validation and the coefficient estimation results are subject to estimation errors, a Monte-Carlo simulation of 20 runs is performed with the Lasso, Lasso-Lasso, Lasso-ridge, and KILR on the NOx data. The dataset is equally divided into 14 segments to perform seven-fold cross-validation with each fold containing two segments randomly.

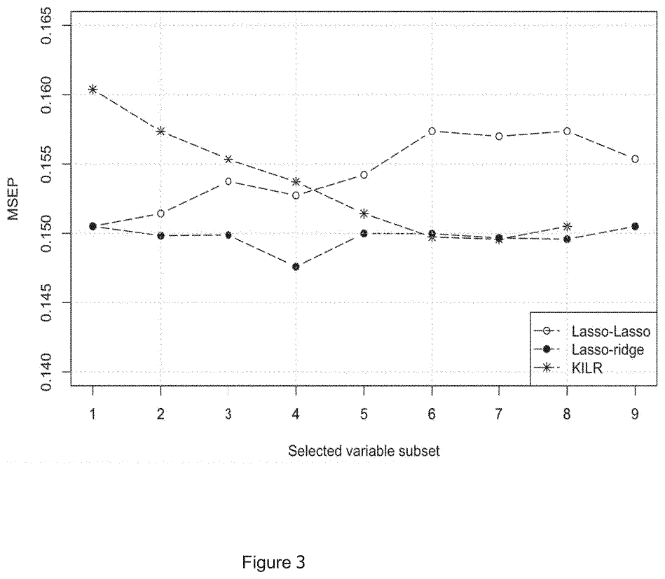

FIG. 3 shows the box plot of the MSEPs of the four modelling methods. The results of 20 Monte-Carlo runs show that Lasso-Ridge models achieve the lowest median MSEP, which is preferred for prediction, while the KILR model with the KI variable achieves the best MSEP in terms of the interquartile range (i.e., the middle 50-percentile).

TABLE II

| | Lasso | Lasso-Lasso | Lasso-ridge | KILR |
|---|---|---|---|---|
| (Intercept) | 0 | 0 | 0 | 0 |
| Air Flow | −1.520 | 0 | 0 | 0 |
| Fuel Flow | 0 | 0 | 0 | 0 |
| Stack Oxygen | 0.116 | 0 | 0 | 0.057 |
| Steam Flow | 1.762 | 0 | 0 | 0.746 |
| Econ. Inlet Temp | 0.139 | 0 | 0.225 | 0.202 |
| Stack Press | −0.709 | 0 | 0 | −0.748 |
| Windbox Press | 1.185 | 0.925 | 0.403 | 0.677 |
| Feedwater Flow | 0.069 | 0 | 0.316 | 0.054 |
| Ambient Temp | −0.058 | 0 | −0.062 | −0.065 |
| MSEP | 0.157 | 0.151 | 0.149 | 0.150 |
| Q² | 0.842 | 0.848 | 0.851 | 0.850 |

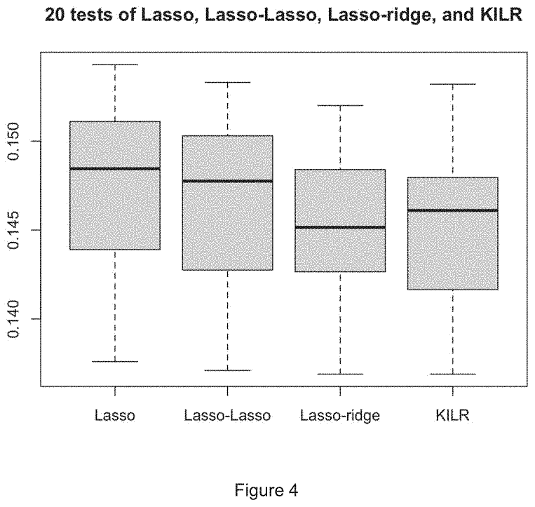

TABLE II shows the regression coefficients, the optimal MSEPS, and Q2 of the Lasso-Lasso, Lasso-Ridge, and KILR models. FIG. 4 shows the minimum MSEP's achieved by the Lasso-Lasso, Lasso-ridge, and KILR based on the candidate model structures along the Lasso paths.

Dow Distillation Data

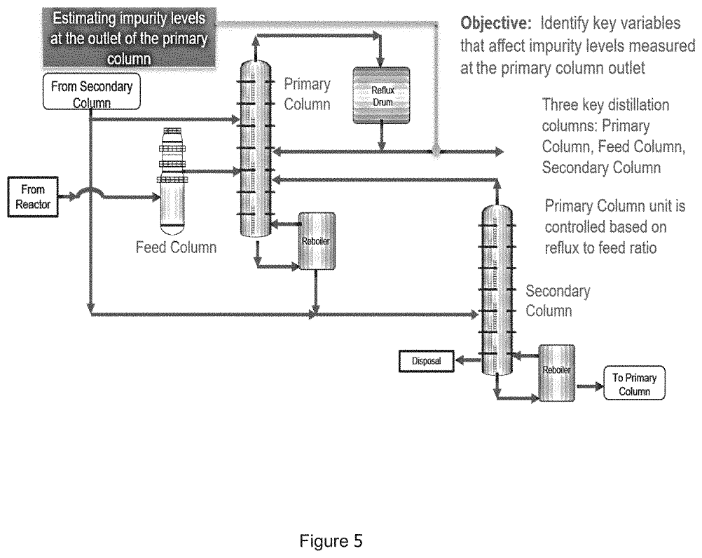

FIG. 5 is a schematic drawing of a process in three distillation columns of the well-known company Dow.

Data collected from three distillation columns were used for modelling impurities that may be produced in the process. The impurity of the primary column is the key quality variable to be predicted and controlled. Data of 44 process variables was used for selection of variables to build the best model. Pre-processed data was used to show the effectiveness of the KILR algorithm. The number of training samples after pre-processing is around 1,800, which can be used to build the models and determine the hyper-parameters.

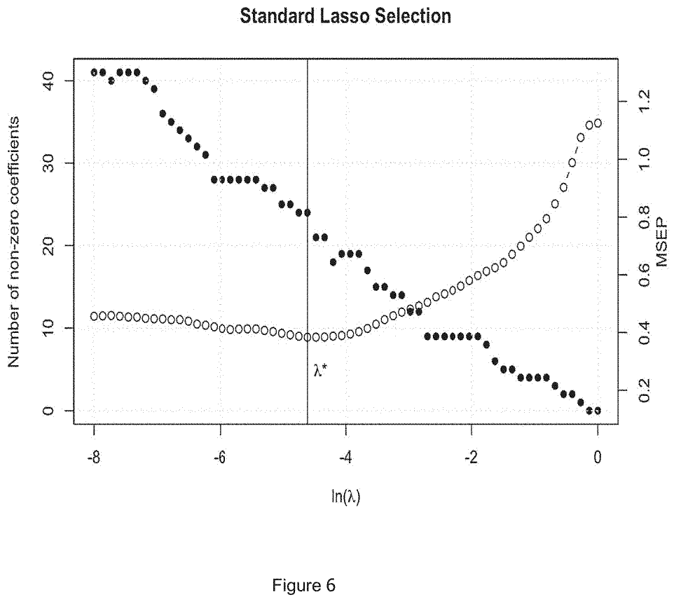

The candidate subsets of variables selected along the Lasso solution path by fitting the model to all training data. The optimal Lasso model is built with seven-fold cross-validation to establish the baseline for comparison. FIG. 6 depicts the MSEPs for a grid of A via cross validation are shown with circles. The minimum MSEP is achieved by the Lasso model with 24 predictors, which is indicated by the vertical line in the figure.

The Lasso-Lasso and Lasso-Ridge cross-validation results with the candidate subsets of variables selected along the Lasso path. It is observed that the MSEPs obtained by the Lasso-Lasso and Lasso-Ridge are smaller than that by the Lasso. The optimal MSEP of the Lasso-Lasso model is achieved with five process variables, while that of the Lasso-Ridge model is achieved with 18 variables. In both models the numbers of selected variables are smaller than the Lasso model with 24 variables, but they achieve significantly smaller MSEPs than the Lasso model.

The regression coefficients of the Lasso, the Lasso-Lasso, and the Lasso-Ridge models Ridge has been observed that large coefficient predictors of the Lasso-Lasso and Lasso-Ridge are also dominant predictors of the Lasso model. Further, the Lasso model selects more predictors than the other two models, but its MSEPs are larger than the Lasso-Lasso and Lasso-Ridge which use fewer predictors.

From the modelling results a variable of the PC-Reflux-Flow is not selected in any of the three models, but it is known that this variable is an important manipulated variable to control the impurity. Therefore, the KILR algorithm is used to build another model with the PC-Reflux-Flow identified as a KI variable. The modified Lasso algorithm is applied to the data to generate a series of candidate subsets of variables along the solution path. Ridge The KILR algorithm achieves a significantly better MSEP, thus, a model with better prediction accuracy and with the desired variable PC-Reflux-Flow.

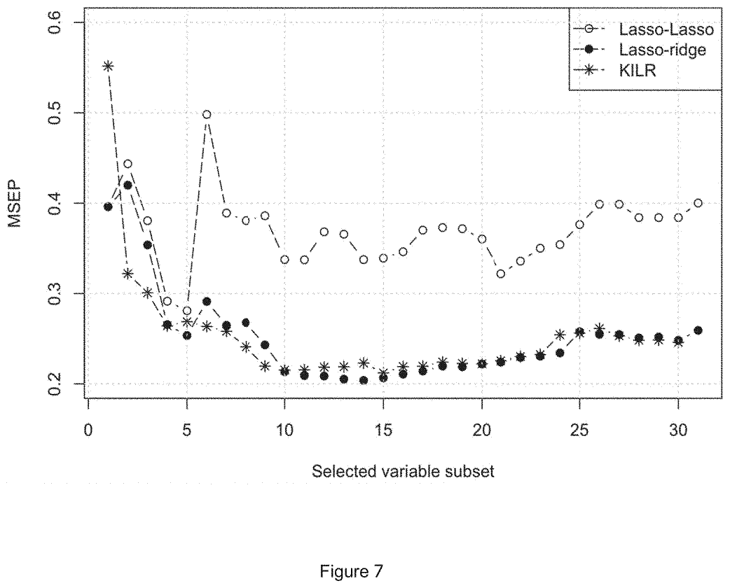

FIG. 7 compares the minimum MSEPs from each candidate set of variables among the three methods: Lasso-Lasso, Lasso-ridge, and KILR. It is seen that the Lasso-Ridge and KILR achieve similar MSEPs, while the Lasso-Lasso achieves much higher MSEPs for most cases. To further compare various models, the optimal cross-validated MSEPs and Q² indices of the optimal Lasso, the Lasso-Lasso, and the Lasso-Ridge models are shown in Table Ill. In addition, the Relaxo algorithm which relaxes the Lasso solution is also applied to the Dow data and the results are shown in the table. It is clear that the Lasso-Lasso and Relaxo give similar MSEPs, which is not surprising since these methods share similar ideas. The Lasso gives the worst model prediction accuracy, while the Lasso-Ridge and KILR give the best model prediction accuracy. Most importantly, the KILR model includes the PC-RefluxFlow in the selected variables as desired.

TABLE III

| | Lasso | Lasso-Lasso | Relaxo | Lasso-ridge | KILR |
|---|---|---|---|---|---|
| MSEP | 0.384 | 0.281 | 0.280 | 0.204 | 0.212 |
| Q2 | 0.614 | 0.719 | 0.720 | 0.796 | 0.788 |

While the KILR model includes PC-Reflux-Flow with a relatively large coefficients, it removes three other variables: PC-Bed1-DP, PC-Make-Flow, and FC-Tails-Flow. Table IV depicts their correlation coefficients, which shows that these variables are highly collinear. As a consequence, the KI variable PC-Reflux-Flow replaces the three variables that have large coefficients in the Lasso model, leading to a physically insightful model with high prediction accuracy.

Since the pair-wise correlations are only able to measure collinearity between two variables, the mutual representability among the four variables is calculated and shown in Table V. It clearly shows that the KI variable PC-Reflux-Flow is represented by the other three variables with 99.2%, which reveals why the purely data-driven methods of the prior art do not select this variable.

TABLE IV

| | PC-Reflux-Flow | ×10 | ×6 |
|---|---|---|---|
| PC-Make-Flow | 0.956 | | |
| PC-Bed1-DP | 0.942 | 0.921 | |
| PC-Tails-Flow | 0.957 | 0.959 | 0.931 |

TABLE V

| | ρⱼ by others |
|---|---|
| PC-Reflux-Flow | 0.992 |
| PC-Make-Flow | 0.979 |
| PC-Bed1-DP | 0.960 |
| PC-Tails-Flow | 0.990 |

Accordingly, the knowledge-informed Lasso-Ridge method is successfully developed and demonstrated to guarantee that relevant variables based on process knowledge are included in the sparse model. Another advantage of the method is that the Ridge regression searches for the optimal hyperparameter independently from the first Lasso step that determines the model structure. Two industrial application studies clearly demonstrate that the Knowledge-informed Lasso-Ridge method gives the best model predictions as well as a model that is guaranteed to include physically relevant variables. The concept of variable representability is effective to characterize the degree of multi-collinearity among variables. The results reveal that the celebrated Lasso method that combines the variable selection and the non-zero parameter optimization problems into one step is sub-optimal.

1. A method of controlling the output of an industrial process, comprising the steps of:
a) obtaining data for variables in an industrial process;
b) identifying key-variables among the variables;
c) treating the data with using Least Absolute Shrinkage And Selection Operator (Lasso) type regression in which the value of a factor is selected and applied to the parameter of each variable that is not a key-variable to produce a model of the industrial process;
d) applying the model to tune the variables to control the output.

2. A method of controlling the output of an industrial process as claimed in claim 1, wherein the Lasso type regression is:
Lasso regression;
Lasso-Ridge regression; or
Lasso-Lasso regression.

3. A method of controlling the output of an industrial process as claimed in claim 1, comprising the further steps of:
preliminarily treating the data with using Lasso regression or Least Angle Regression (LARS) in which the value of a factor is selected and applied to the parameter of each variable to produce a preliminary model; and
if the preliminary treatment renders the parameter of a key variable to zero, performing step c) and step d);
if the preliminary treatment does not render the parameter of any key variable to zero, providing the preliminary model as the model of the industrial process.

4. A method of controlling the output of an industrial process as claimed in claim 1, wherein
the process is a chemical process.

5. A method of controlling the output of an industrial process as claimed in claim 4, wherein
the process is a pharmaceutical process.

6. A method of controlling the output of an industrial process as claimed in claim 4, wherein
the process is food making process.
